(19) United States
(12) Patent Application Publication
(10) Pub. No.: US 2010/0315396 A1
(43) Pub. Date: Dec. 16, 2010

(54) TIMING CONTROLLER, DISPLAY AND CHARGE SHARING FUNCTION CONTROLLING METHOD THEREOF

(75) Inventors: Meng-Tse Weng, Tainan County (TW); Ying-Lieh Chen, Tainan County (TW); Chien-Ru Chen, Tainan County (TW); Chuan-Che Lee, Tainan County (TW)

Correspondence Address: J C PATENTS, 4 VENTURE, SUITE 250, IRVINE, CA, 92618, US

(73) Assignee: HIMAX TECHNOLOGIES LIMITED, Tainan County (TW)

(21) Appl. No.: 12/481,859

(22) Filed: Jun. 10, 2009

(51) Int. Cl. G09G 5/00; G09G 3/36

(52) U.S. Cl. 345/208; 345/92

(57) ABSTRACT

A display, which includes a display panel, a timing controller, and a source driver is provided. The timing controller analyzes gray level distribution of a video data to obtain an analysis result. The source driver is coupled between the display panel and the timing controller for driving the display panel to display a corresponding frame according to a video signal provided by the timing controller, and further the timing controller enables or disables a charge sharing function of the source driver in the display according to the analysis result. As a result, the charge sharing function is enabled optionally during different charge sharing periods, and thus the power consumption and the operation temperature of the source driver could be reduced as compared with the prior art.

### BACKGROUND OF THE INVENTION

1. Field of the Invention

The present invention relates to a timing controller. More particularly, the present invention relates to a timing controller for controlling a charge sharing function of a source driver in a display and a method thereof.

2. Description of Related Art

Flat panel display apparatus, e.g. thin film transistor-liquid crystal display (TFT-LCD), has been proposed to serve as a replacement of a conventional cathode ray tube (CRT) display apparatus. As compared with the conventional CRT display, the TFT-LCD apparatus has advantages such as having relatively low voltage action, low power consumption, thin and small size, and light weight.

FIG. 1A shows a conventional LCD 100. The display 100 includes, a timing controller TCON, a source driver SD, and a display panel 130, wherein the source driver SD includes a plurality of source driver units 120 and 121. Each source driver unit (e.g. the source driver unit 120) respectively includes an interface circuit 122, a digital-analog converter (DAC) 124, and an output buffer 126. The conventional LCD 100 uses the timing controller TCON to generate various control signals to the source driver SD and the gate driver (not shown) for controlling the source driver SD and the gate driver (not shown) to operate. Under the control of the control signals, the gate driver (not shown) sequentially drives each gate line and then the source driver units 120 and 121 in the source driver SD output voltages V136 and V137. The operation detail of each source driver unit is known by those skilled in the art, so it is not described here.

The display panel 130 has a plurality of data lines (for example data lines 136 and 137). Each data line is respectively coupled to a plurality of sub-pixel units (here only sub-pixel units 139 and 140 are shown). One group of the sub-pixel units connected by the data line 136 includes a transistor 132 and a liquid crystal capacitor 134. The logic state of the transistor 132 is controlled through the signal of a corresponding scan line 131, and the source driver unit 120 can store the charge signal in the capacitor 134. The capacitor 134 stores the data of the data line 136 based on the common voltage Vcom, and the transmittance of the sub-pixel unit is determined by the potential difference of the two ends of the liquid crystal capacitor 134. FIG. 1B is a signal timing diagram illustrating an even data line and an odd data line (here the data line 136 and the data line 137 are used for illustration) in FIG. 1A. The conventional large panel mostly adopts the direct current (DC) common voltage Vcom design, so the data lines 136 and 137 of the display panel 130 have a negative polarity voltage (represented by −) lower than the common voltage Vcom, and a positive polarity voltage (represented by +) higher than the common voltage Vcom. The data line is alternatively driven by the positive polarity voltage and the negative polarity voltage. For example, the voltage swing of the voltage V136 of the data line 136 is SW1A, and the voltage swing of the voltage V137 of the data line 137 is SW1B, as shown in FIG. 1B. The voltage swing width is related to the consumed power magnitude. However, according to the conventional method, the voltage swing at the source driver unit 120 is too large and the consumed power is too large, and the temperature of the source driver unit 120 is too high.

In order to solve the said problem that the consumed power of the source driver unit 120 is too large, FIG. 1C shows a conventional display 150 which includes a charge sharing circuit for reducing the swing of the voltage used to drive the corresponding data line by the source driver unit (for example source driver units 160 and 170). The display 150 in FIG. 1C includes a timing controller TCON, a source driver SD, and a display panel 180, wherein the source driver SD includes a plurality of driver units (for example the driver unit 160 and the driver unit 170) and switches 172, 174, and 176 (i.e. the charge sharing circuit). Each source driver unit (for example the source driver unit 160) includes an interface circuit 162, a DAC 164, and an output buffer 166. In the LCD 150, the timing controller TCON generates various control signals to the source driver SD and the gate driver (not shown) for controlling the source driver SD and the gate driver (not shown) to operate. Under the control of the control signals, the gate driver (not shown) sequentially drives each gate line and then the source driver units 160 and 170 output voltages V186 and V187.

FIG. 1D is a signal timing diagram of an even data line and an odd data line (here the data line 186 and the data line 187 are used for illustration) in FIG. 1C. In a charge sharing period t1, the switch 172 and the switch 176 are in the OFF state, and the switch 174 is in the ON state, so the charging sharing is generated between the data lines 186 and 187 due to short circuit. Therefore, in the charge sharing period t1, the voltage V186 of the data line 186 and the voltage V187 of the data line 187 converge to approximately the common voltage Vcom, and this is the operation of the charge sharing function. After the charge sharing period t1 is end, the process proceeds to a normal driving period t2, at this time, the switch 172 and the switch 76 are in the ON state, and the switch 174 is in the OFF state, such that the source driver units 160 and 170 can drive the data lines 186 and 187. The detail of the driving operation is known by those skilled in the art, so it is not described here.

It is known from FIG. 1D that by the operation of the charge sharing function, in the charge sharing period t1, the voltage level on the data line 186 is drawn to the common voltage Vcom in advance. Therefore, in the normal driving period t2, the swing SW1C of the voltage of the source driver unit 160 for driving the data line 186 is reduced. After the normal driving period t2 is end, the process proceeds to a charge sharing period t3, and the internal circuit of the display 150 begins to perform the charge sharing function again, so as to repeatedly perform the same activity. Though the operation of the charge sharing function, the swing of the voltage of the source driver unit for driving the data line can be greatly reduced, thereby reducing the power consumption of the source driver unit, and achieving the function of power saving.

However, taking column inversion driving method as an example, when a white frame is displayed in the conventional display 150 shown in FIG. 1C, the voltage V186 of the data line 186 and the voltage V187 of the data line 187 are illustrated as FIG. 1E due to no video data changed. In the meanwhile, if the charge sharing circuit (i.e. the switch 172, 174, 176, and so on) still works during the charge sharing period t1 and t3, there will be an undesired phenomenon similar to toggles shown in FIG. 1F occurring in the voltages V186 and V187. The unexpected situation may cause the operation temperature of the source driver SD to become higher. Therefore, it is desirable to design a proper display apparatus to solve the said problem.

### SUMMARY OF THE INVENTION

Accordingly, the present invention is directed to provide a display, capable of controlling a charging sharing function of a source driver by using a timing controller in the display to save the power consumption in the source driver and to lower the operation temperature of the source driver.

The present invention also provides a timing controller, capable of controlling a charging sharing function of a source driver in the display to save the power consumption in a source driver and to lower the operation temperature of the source driver.

The present invention further provides a charging sharing controlling method of a source driver in the display to save the power consumption in the source driver therein and to lower the operation temperature of the source driver.

In order to solve the problems of the prior art, the present invention provides a display, which includes a display panel, a timing controller, and a source driver. The timing controller analyzes gray level distribution of a video data to obtain an analysis result. The source driver is coupled between the display panel and the timing controller for driving the display panel to display a corresponding frame according to the video data provided by the timing controller, and further the timing controller enables or disables a charge sharing function of the source driver in the display according to the analysis result.

In order to solve the problems of the prior art, the present invention provides a timing controller. The timing controller in a display outputs a synchronous signal and a video signal carrying the video data to a source driver in the display, and analyzes gray level distribution of the video data to obtain an analysis result. The timing controller enables or disables a charge sharing function of the source driver according to the analysis result.

The present invention further provides a charge sharing controlling method of a source driver. The method includes analyzing gray level distribution of a video data to obtain an analysis result by using a timing controller, and enabling or disabling the charge sharing function of the source driver in the display according to the analysis result.

The timing controller and the charge sharing controlling method provided by the present invention can control the charge sharing function of the source driver in the provided display, such that the power consumption and the operation temperature of the source driver therein is both reduced.

In order to make the features and advantages of the present invention comprehensible, preferred embodiments accompanied with figures are described in detail below.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A shows a conventional LCD.

FIG. 1B is a signal timing diagram illustrating an even data line and an odd data line in FIG. 1A.

FIG. 1C shows a conventional display.

FIG. 1D is a signal timing diagram of an even data line and an odd data line in FIG. 1C.

FIG. 1E is a signal timing diagram of an even data line and an odd data line in a while frame without a charge sharing function in FIG. 1C.

FIG. 1F is a signal timing diagram of an even data line and an odd data line in a while frame with a charge sharing function in FIG. 1C.

FIG. 2 is a simplified block diagram of an electronic display apparatus according to an embodiment of the present invention.

FIG. 3 is a simplified block diagram of a data analysis unit in the timing controller shown in FIG. 2 according to an embodiment of the present invention.

FIG. 4 is a simplified block diagram of a data analysis unit in the timing controller shown in FIG. 2 according to another embodiment of the present invention.

FIG. 5 is a data transmitting mode of the video data.

FIG. 6 is a simplified block diagram of an electronic display apparatus according to an embodiment of the present invention.

FIG. 7 is a timing diagram showing waveforms of signals transmitted from the timing controller to the source driver according to the embodiment of the present invention.

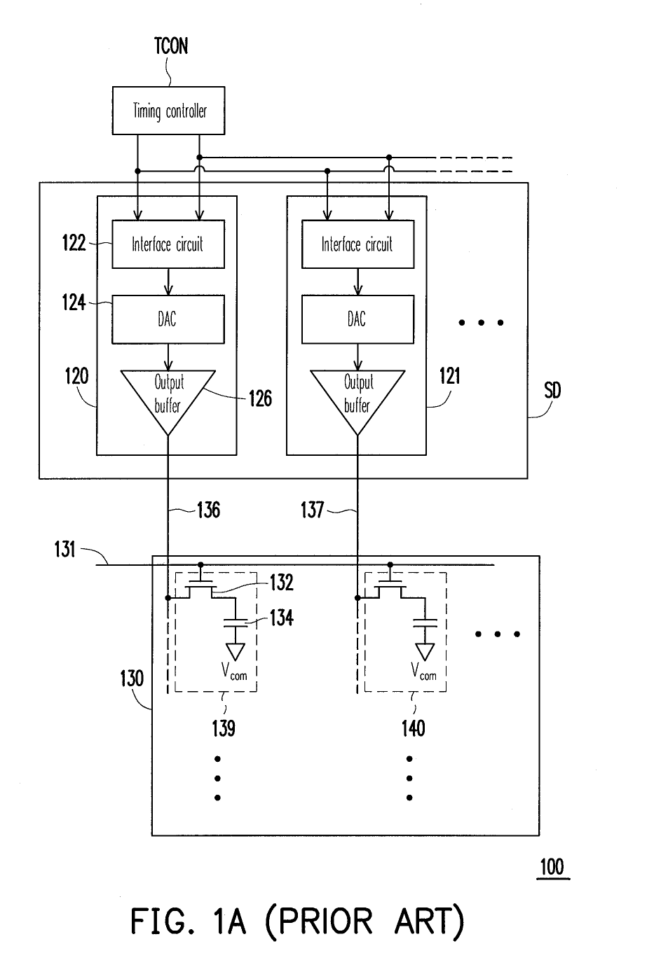

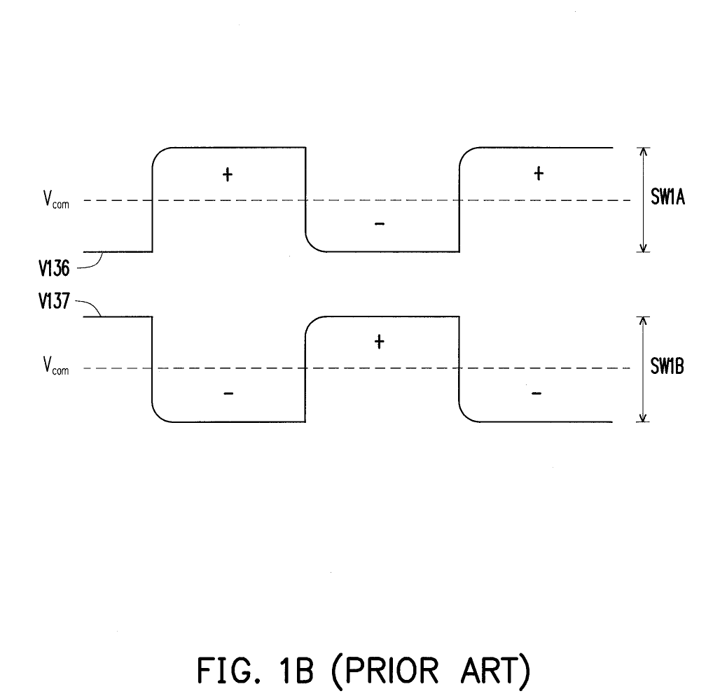

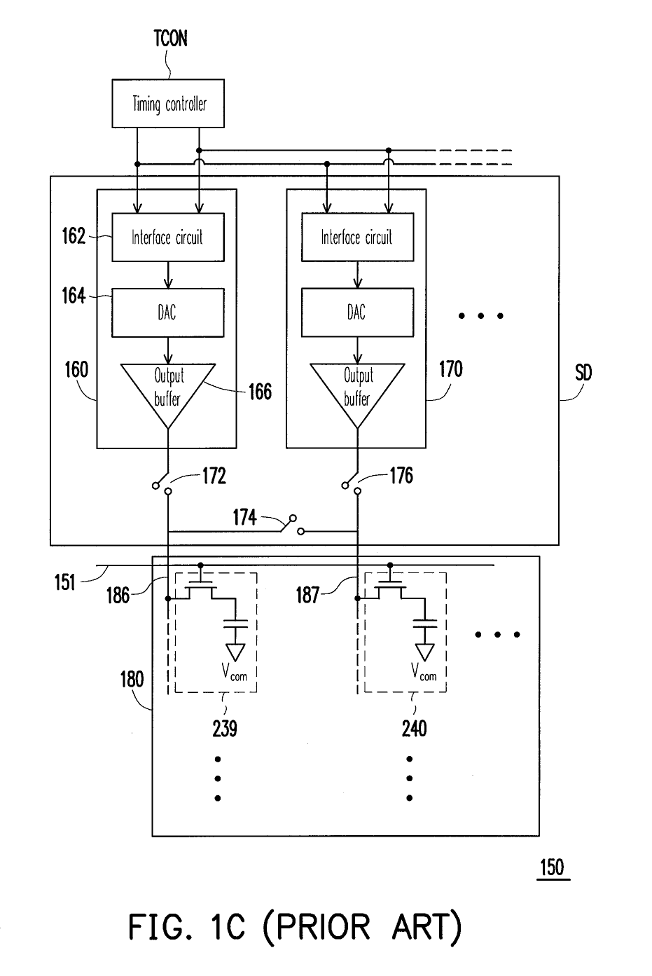

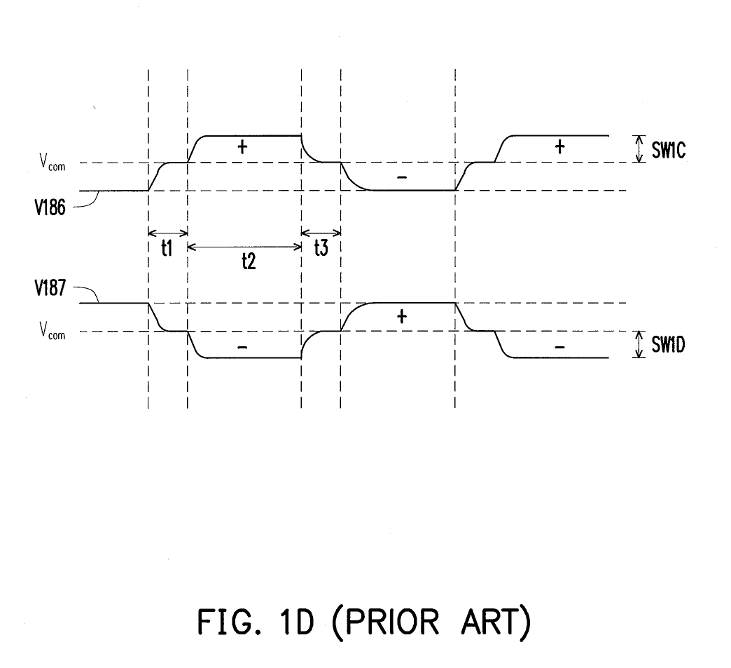

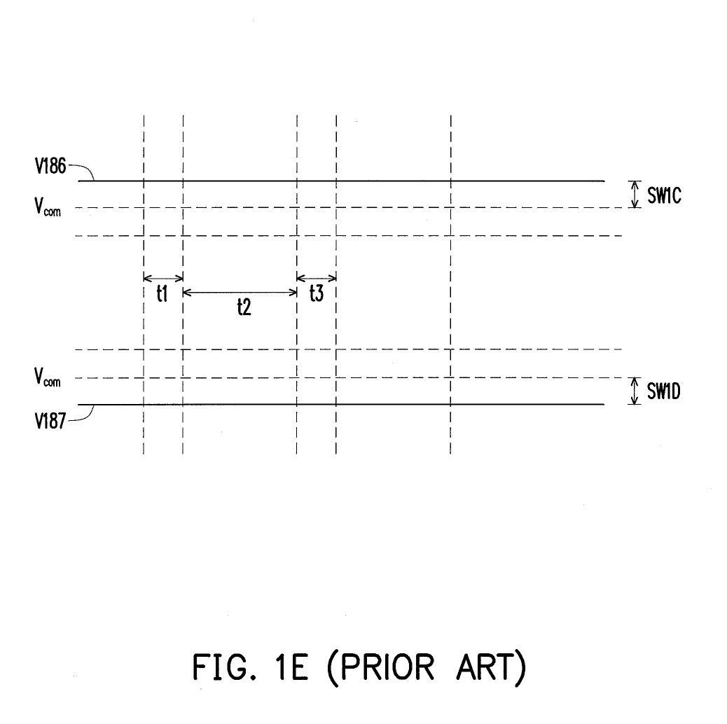

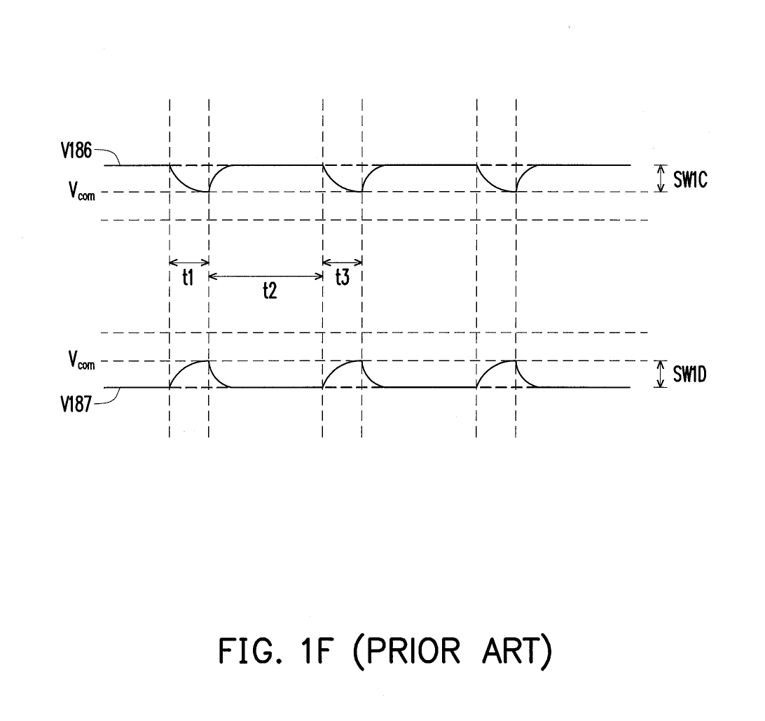

### DESCRIPTION OF EMBODIMENTS

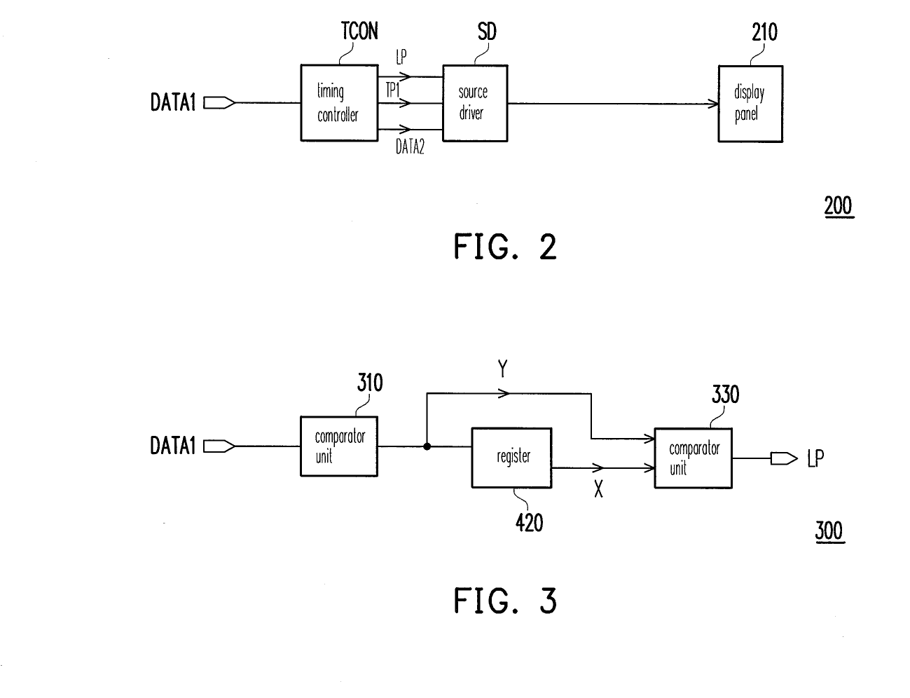

FIG. 2 is a simplified block diagram of an electronic display apparatus according to an embodiment of the present invention. In this embodiment, the electronic display apparatus 200 is a TFT-LCD. As shown in FIG. 2, a video data DATA1 is received by a timing controller TCON, wherein gray level distribution of the video data DATA1 is analyzed by the timing controller TCON. Then, an analysis result is obtained from the timing controller TCON, which is corresponding to a charge-sharing mode signal LP in this embodiment. After that, the charge-sharing mode signal LP, a synchronous signal TP1 and a video signal DATA2 carrying the video data DATA1 are transmitted from the timing controller TCON to a source driver SD. Herein,. the source driver SD is coupled between the display panel 210 and the timing controller TCON for driving the display panel 210 to display a corresponding frame according to the video signal DATA2 provided by the timing controller TCON.

It should be noted that the timing controller TCON enables or disables a charge sharing function of the source driver SD in the electronic display apparatus 200 according to a logic level of the charge-sharing mode signal LP. Therefore, the charge sharing function is enabled optionally during different charge sharing periods. This embodiment is exemplified by utilizing the TFT-LCD and the charge-sharing mode signal LP for controlling the charge sharing function, but the present invention is not limited thereto.

FIG. 3 is a simplified block diagram of a data analysis unit 300 in the timing controller TCON shown in FIG. 2 according to an embodiment of the present invention. In this embodiment, the data analysis unit 300 includes a counter unit 310, a register 320, and a comparator unit 330 for dynamically analyzing gray level distribution of the video data DATA1. For example, while the video data DATA1 is transmitted to the counter unit 310, the counter unit 310 counts a most significant bit (MSB) of the video data DATA1. If a logic state of the MSB is high, which is denoted as “1” for example, the counter unit 310 counts an amount of the logic state of the MSB, and thus an output result X is obtained from the counter unit 310. Then, the output result X is registered in the register 320. Meanwhile, the output result X is delivered to the comparator unit 330, and the counter unit 310 and the register 320 are both reset in a period. After that, the counter unit 310 proceeds to count a high MSB of the video data DATA1 in the next period, and another output result Y of the counter unit 310 is delivered to the register 320 for registering. In the meanwhile, the counter unit 310 also delivers the output result Y to the comparator unit 330 for comparing with the output result X and a threshold gray level value Z. According to a comparing result, the comparator unit 330 outputs the charge-sharing mode signal LP, and the logic level of the charge-sharing mode signal LP is decided.

Besides, the output results X and Y compared by the comparator unit 330 represent gray level distribution of the video data DATA1 in a first scan line (not shown) and in a second scan line (not shown), respectively, and the threshold gray level value Z is related to a threshold gray level. For example, if gray levels of the video data DATA1 have levels 0-255, then, the proceeding—50% gray levels are the levels 0-127 (darker regions of an image), while the following—50% gray levels are the levels 128-255 (brighter regions of an image). Consequently, the threshold gray level value Z is the level 127 or 128. Herein, the high MSB mentioned above represents a gray level of the video data DATA1 corresponding to a brighter pixel. That is, if the output result X is greater than the threshold gray level value Z (i.e. X>Z), it means gray level distribution of the video data DATA1 in the first scan line is brighter. In other words, if the output result Y is greater than the output result X (i.e. Y>X), gray level distribution of the video data DATA1 in the second scan line is brighter than gray level distribution of the video data DATA1 in the first scan line.

Note that the threshold gray level value Z corresponding to proceeding—50% gray levels and following—50% gray levels of the gray levels 0-255 mentioned in the embodiment are considered as a specific implementation. Anyone skilled in the art would be able to modify the mentioned proceeding—50% gray levels and following—50% gray levels into proceeding—60% gray levels, and following—40% gray levels or proceeding—40% gray levels and following—60% gray levels, etc. Therefore, the present invention is not limited to the above-mentioned specific implementation.

Referring to FIG. 2 and FIG. 3, as known from above, if the analysis result obtain from the data analysis unit 300 is the output result Y greater than or equal to the output result X (i.e. Y≧X), the logic level of the charge-sharing mode signal LP transmitted from the display panel 210 to the source driver SD is high, and thus the timing controller TCON disables the charge sharing function of the source driver SD during a charge sharing period according to the logic level of the charge-sharing mode signal LP. Similarly, if the analysis result is Y<X and Y>Z, the logic level of the charge-sharing mode signal LP is high, and the the timing controller TCON disables the charge sharing function. In contrast, if the analysis result is Y<X and Y<Z the logic level of the charge-sharing mode signal LP is low, and the timing controller TCON enables the charge sharing function according to the logic level of the charge-sharing mode signal LP.

Therefore, by using the approach mentioned above to analyze the gray level distribution of the video data DATA1 in any two scan lines of the display panel 210, the timing controller TCON outputs the charge-sharing mode signal LP to the source driver SD, and optionally enables the charge sharing function of the source driver SD during different charge sharing periods according to the logic level of the charge-sharing mode signal LP. Besides, in this embodiment, the data transmitting interface between the timing controller TCON and the source driver SD, for example, is reduced swing differential signaling (RSDS).

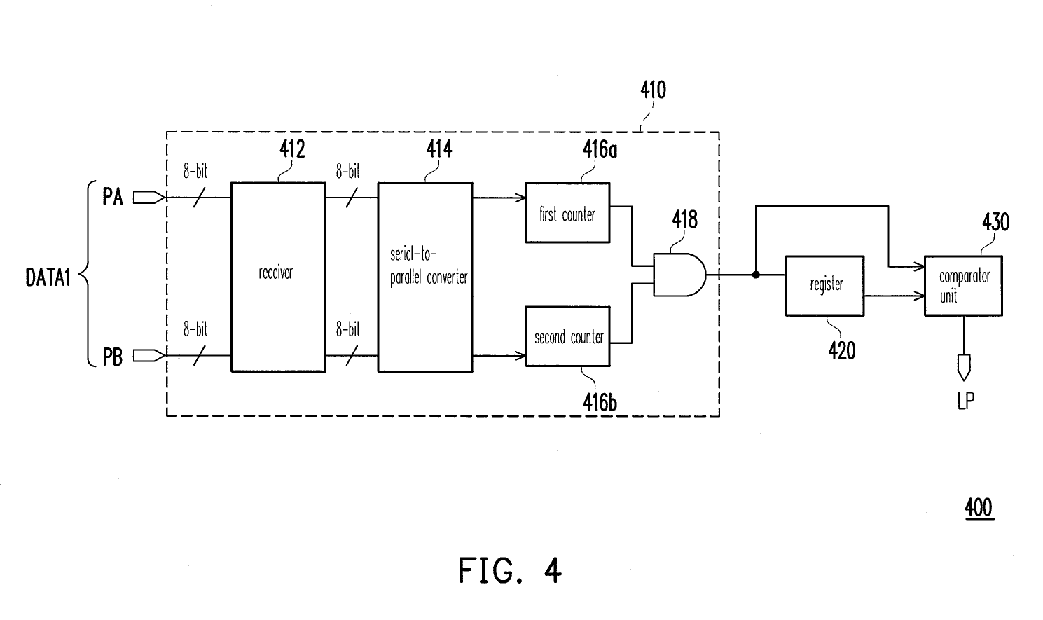

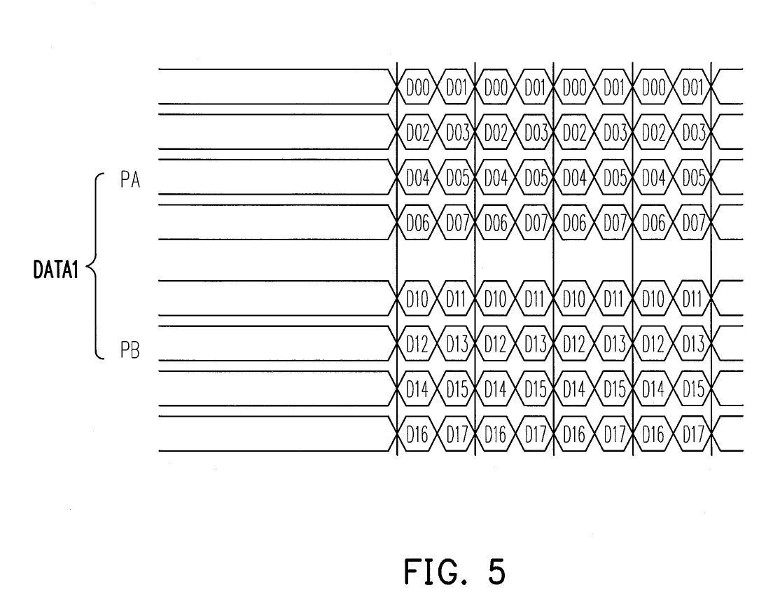

FIG. 4 is a simplified block diagram of a data analysis unit 400 in the timing controller TCON shown in FIG. 2 according to another embodiment of the present invention. FIG. 5 is a data transmitting mode of the video data DATA1. In this embodiment, the video data DATA1 is transmitted to the data analysis unit 400 in the timing controller TCON through two data pairs, such as a first data pair PA and a second data pair PB. Herein, the first data pair PA and the second data pair PB are both taken 8-bits as an example shown in FIG. 5. Referring to FIG. 4 and FIG. 5, a receiver 412 in the data analysis unit 400 receives the first data pair PA and the second data pair PB, and then transmits the first data pair PA and the second data pair PB to a serial-to-parallel converter 414. Then, the serial-to-parallel converter 414 converts the first data pair PA and the second data pair PB from serial data to parallel data, and transmits the first data pair PA and the second data pair PB to a first counter 416a and a second counter 416b, respectively. After that, the first counter 416a counts the high MSB of the parallel data related to the first data pair PA. While a counting result of the first counter 416a is greater than a threshold gray level value Z, the first counter 416a transmits a high logic level to a logic gate 418. In the meanwhile, if a counting result of a second counter 416b related to the second data pair PB is also greater than the threshold gray level, the second counter 416b transmits the high logic level to the logic gate 418.

Herein, the logic gate 418 is an AND gate for example, and thus the AND gate outputs the high logic level to a register 420 for registering the first logic result X from the AND gate. In other embodiment, the logic gate 418 can also be implemented by an OR gate, but the threshold gray level value Z should be changed correspondingly. The first logic result registered in the register 420 is delivered to the comparator unit 430, and the first counter unit 416a, the second counter unit 416a and the register 420 are both reset in a period. Then, the counter unit 410 proceeds to count the high MSB of the video data DATA1 in the next period. Similar to the approach for analyzing the video data DATA1, a second logic result Y from the AND gate is delivered to the register 420 for registering and to the comparator unit 430 for comparing with the first logic result X.

While the first logic result X is a high logic level and the second logic result Y is a low logic level, it means gray level distribution of the video data DATA1 in the first scan line (not shown) is brighter than in the second scan line (not shown), and thus the comparator unit 430 outputs a low logic level of the charge-sharing mode signal LP to the source driver SD. As a result, the timing controller TCON enables the charge sharing function of the source driver SD according to the low logic level of the charge-sharing mode signal LP. It should be noted that the comparator unit 430 outputs a high logic level of the charge-sharing mode signal LP under other conditions of the first and second logic results X and Y in this embodiment. Therefore, by using the approach mentioned above to analyze the gray level distribution of the video data DATA1 in any two scan lines of the display panel 210 shown in FIG. 2, the timing controller TCON optionally enables the charge sharing function of the source driver SD during different charge sharing periods according to the logic level of the charge-sharing mode signal LP from the timing controller TCON.

The implement of the data analysis unit in the timing controller TCON for dynamically analyzing gray level distribution of the video data DATA1 may have many varieties, especially the counting unit and the data transmitting mode. The block design schematically shown in FIG. 2, FIG. 3 and FIG. 4 is only illustrated as an example for one skilled in the art to implement the present invention, rather than limiting the scope of the present invention.

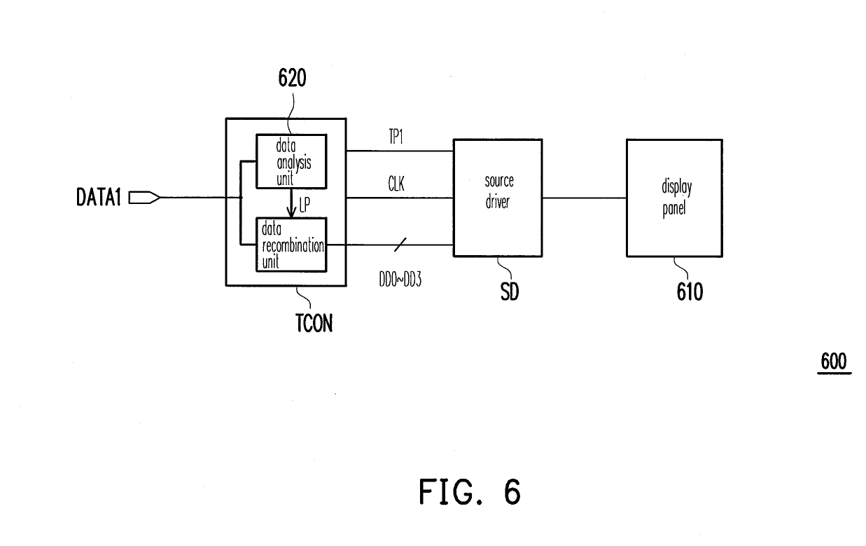

FIG. 6 is a simplified block diagram of an electronic display apparatus according to an embodiment of the present invention. With reference to FIG. 6, the electronic display apparatus 600 of the present embodiment is similar to the electronic display apparatus 200 illustrated in the above embodiment except that the timing controller TCON of the present embodiment further includes a data recombination unit 630 coupled with a data analysis unit 620, wherein the data recombination unit 630 recombines a charge-sharing mode signal LP outputted from the data analysis unit 620 and the video data DATA1 to generate the video signal DD0-DD3. In the present embodiment, the charge-sharing mode signal LP is combined into the video signal DD0-DD3, and thus a charge sharing function of the source driver SD is enabled or disabled according to the video signal DD0-DD3.

As shown in FIG. 6, signals (i.e. a synchronous signal TP1, a clock signal CLK, and the video signal DD0-DD3) are transmitted from the timing controller TCON in this embodiment, to the source driver SD. This embodiment is exemplified by utilizing the video signal DD0-DD3, but the present invention is not limited thereto.

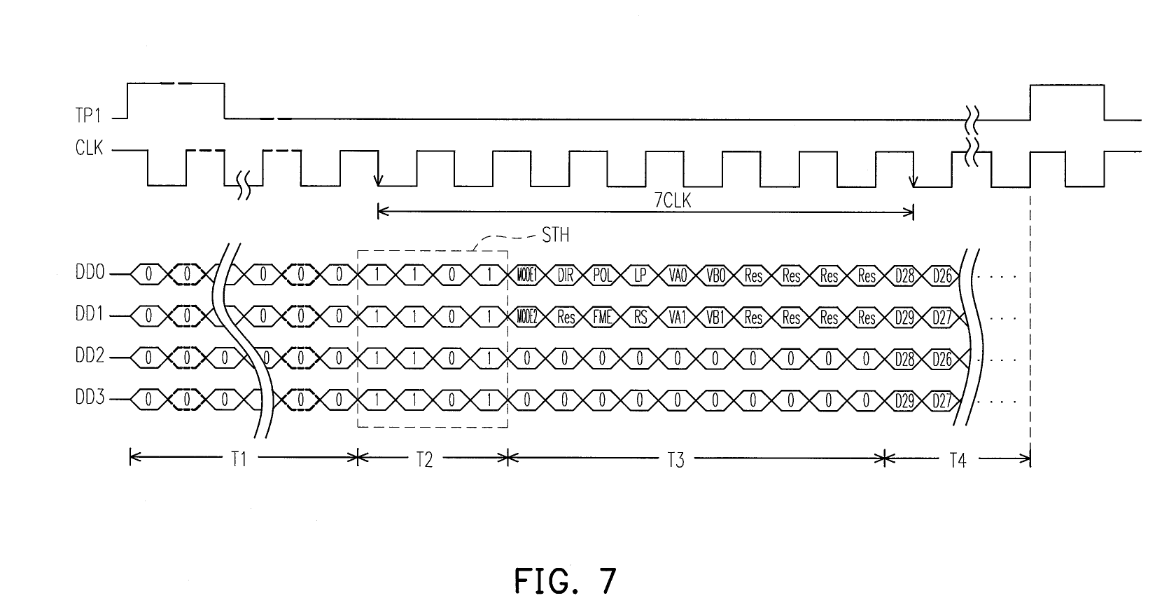

FIG. 7 is a timing diagram showing waveforms of signals transmitted from the timing controller to the source driver SD according to the embodiment of the present invention. A plurality of setting signals, which are used to adjust the setting of the electronic display apparatus 600, are transmitted to the source driver SD.

After outputting the synchronous signal TP1, the timing controller TCON sends signals, for driving pixels of the display panel 610, to the source driver SD. During the period T1 (shown in FIG. 7), signals transmitted are kept to be 0 (i.e. low) due to the preservation of energy. During the period T2, the video signal DD0-DD3 includes a start pulse pattern STH, e.g. a data sequence of “1-1-0-1” in this embodiment, to the source driver SD. The start pulse pattern STH notices the source driver SD to receive the setting signals and the display data signals for driving the pixels of the display panel 610. After outputting the start pulse pattern STH, the timing controller TCON transmits the setting signals to the source driver SD within a setting period T3 such that the electronic display apparatus 600 could be set according to the setting signals.

During the setting period T3, several setting signals within the video signal DD0-DD3 are sent from the timing controller TCON to the source driver SD. The setting signals transmitted during the setting period T3 may include, for example, DIR, POL, VB1, RS, FME, MODE1/MODE2, VA0, VA1, VB0, and especially the charge-sharing mode signal LP. As a result, the timing controller TCON optionally enables the charge sharing function of the source driver SD during different charge sharing periods according to the logic level of the charge-sharing mode signal LP within the video signal from the timing controller TCON. The transmission sequence of the setting signals may be different in other embodiments of the present invention, and the quantity of the setting signals may be changed based on specific design of the source driver SD and the timing controller TCON.

Relatively, in another embodiment of the present invention, a method for controlling a charge sharing function of a source driver in the electronic display apparatus is provided. The charge sharing controlling method includes: (a) analyzing gray level distribution of a video data DATA1 to obtain an analysis result by using a timing controller TCON; (b) enabling or disabling the charge sharing function of the source driver in the electronic display apparatus according to the analysis result.

In summary, the electronic display apparatus in the said embodiment utilizes the timing controller for analyzing gray level distribution of the video data to obtain an analysis result. Then, according to the analysis result, the timing controller enables or disables a charge sharing function of the source driver in the electronic display apparatus. In an embodiment, the timing controller enables or disables a charge sharing function of the source driver according to the logic level of the charge-sharing mode signal. In another embodiment, the timing controller enables or disables a charge sharing function of the source driver according to the video signal carrying the charge-sharing mode signal. As a result, the charge sharing function is enabled optionally during different charge sharing periods, and thus the power consumption and the operation temperature of the source driver could be reduced as compared with the prior art.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A display, comprising:
a display panel;
a timing controller, for analyzing gray level distribution of a video data to obtain an analysis result; and
a source driver, coupled between the display panel and the timing controller for driving the display panel to display a corresponding frame according to the video data provided by the timing controller;
wherein the timing controller enables or disables a charge sharing function of the source driver according to the analysis result.

2. The display as claimed in claim 1, wherein the timing controller comprises a data analysis unit for dynamically analyzing gray level distribution of the video data, outputting a charge-sharing mode signal, and deciding a logic level of the charge-sharing mode signal according to the analysis result.

3. The display as claimed in claim 2, wherein the data analysis unit outputs the charge-sharing mode signal to the source driver, and the timing controller enables or disables a charge sharing function of the source driver according to the logic level of the charge-sharing mode signal.

4. The display as claimed in claim 2, wherein the timing controller further comprises a data recombination unit, the data analysis unit outputs the charge-sharing mode signal to the data recombination unit, and the data recombination unit recombines the charge-sharing mode signal and the video data to generate a video signal for outputting to the source driver.

5. The display as claimed in claim 4, wherein the data recombination unit outputs the video signal to the source driver, and the timing controller enables or disables a charge sharing function of the source driver according to the video signal carrying the charge-sharing mode signal.

6. The display as claimed in claim 2, wherein the data analysis unit analyzes a logic state of a most significant bit (MSB) of the video data to obtain gray level distribution of the video data.

7. The display as claimed in claim 6, wherein the data analysis unit comprises:
a counter unit, for counting an amount of the logic state of the MSB in the video data, and outputting a counting result in a period;
a register, an input terminal of the register is coupled to an output terminal of the counter unit, wherein the register registers and outputs the counting result of a previous period as a previous counting result; and
a comparator unit, coupled to output terminals of the register and the counter unit, for comparing output results of the register and the counter unit to obtain the analysis result.

8. A timing controller in a display, for analyzing gray level distribution of a video data to obtain an analysis result, outputting a synchronous signal and a video signal carrying the video data to a source driver, and the timing controller enables or disables a charge sharing function of the source driver according to the analysis result.

9. The timing controller as claimed in claim 8, wherein the timing controller comprises a data analysis unit for dynamically analyzing gray level distribution of the video data, outputting a charge-sharing mode signal, and deciding a logic level of the charge-sharing mode signal according to the analysis result.

10. The timing controller as claimed in claim 9, wherein the data analysis unit outputs the charge-sharing mode signal to the source driver, and the timing controller enables or disables a charge sharing function of the source driver according to the logic level of the charge-sharing mode signal.

11. The timing controller as claimed in claim 9, wherein the timing controller further comprises a data recombination unit, the data analysis unit outputs the charge-sharing mode signal to the data recombination unit, and the data recombination unit recombines the charge-sharing mode signal and the video data to generate the video signal.

12. The timing controller as claimed in claim 11, wherein the data recombination unit outputs the video signal to the source driver, and the timing controller enables or disables a charge sharing function of the source driver according to the video signal carrying the charge-sharing mode signal.

13. The timing controller as claimed in claim 9, wherein the data analysis unit analyzes a logic state of a most significant bit (MSB) of the video data to obtain gray level distribution of the video data.

14. The timing controller as claimed in claim 13, wherein the data analysis unit comprises:
a counter unit, for counting an amount of the logic state of the MSB in the video data, and outputting a counting result in a period;
a register, an input terminal of the register is coupled to an output terminal of the counter unit, wherein the register registers and outputs the counting result of a previous period as a previous counting result; and
a comparator unit, coupled to output terminals of the register and the counter unit, for comparing output results of the register and the counter unit to obtain the analysis result.

15. A method for controlling a charge sharing function of a source driver in a display comprising:
analyzing gray level distribution of a video data to obtain an analysis result by using a timing controller; and
enabling or disabling the charge sharing function of the source driver in the display according to the analysis result.

16. The method as claimed in claim 15, wherein analyzing gray level distribution of a video data comprises:
analyzing a logic state of a MSB of the video data to obtain gray level distribution of the video data.

17. The method as claimed in claim 16, wherein analyzing gray level distribution of a video data comprises:
counting an amount of the logic state of the MSB in the video data for obtaining a counting result in a current period;
registering the counting result of a previous period; and
comparing the counting results of the current period and the previous period to obtain the analysis result.
